(19) United States
(12) Patent Application Publication
(10) Pub. No.: US 2008/0160368 A1
(43) Pub. Date: Jul. 3, 2008

(54) FUEL CELL SYSTEM

(75) Inventor: Yasuyuki MURAMATSU, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/965,050

(22) Filed: Dec. 27, 2007

(30) Foreign Application Priority Data
Dec. 27, 2006 (JP) 2006-351590

(51) Int. Cl. H01M 8/04

(52) U.S. Cl. 429/22

(57) ABSTRACT

A fuel cell system is capable of easily detecting an abnormality in an aqueous solution container, a circulation unit or a liquid level adjusting unit. The fuel cell system includes an aqueous solution tank which holds aqueous methanol solution; a level sensor which outputs one of detection signals HIGH and LOW in accordance with the liquid level in the aqueous solution tank; an aqueous solution pump for circularly supplying aqueous methanol solution to a cell stack; a water pump for supplying water to the aqueous solution tank; and a CPU which controls operation of the fuel cell system. The CPU detects that an abnormality exists based on comparison between a first predetermined time and a required time (LOW time) which is a time required for a detection signal to be changed from LOW to HIGH, or on comparison between a second predetermined time and a required time (HIGH time) which is a time required for the detection signal to be changed from HIGH to LOW.

### BACKGROUND OF THE INVENTION

1. Field of the Invention

The present invention relates to fuel cell systems, and more specifically to a fuel cell system in which aqueous fuel solution is circularly supplied to the fuel cell.

2. Description of the Related Art

Generally, there is known a fuel cell system in which aqueous fuel solution held in an aqueous solution container is circularly supplied to the fuel cell by a circulation unit while air which contains oxygen is supplied to the fuel cell. If the circulatory supply of aqueous fuel solution is stopped during power generation due to an abnormality existing in the circulation unit, the fuel cell in such a fuel cell system stops power generation after it has continued power generation for some time, using aqueous fuel solution left in the fuel cell. Since oxygen supply to the cathode (air electrode) of the fuel cell is non-uniform, fuel consumption in the anode (fuel electrode) of the fuel cell increases at regions which correspond to regions of the cathode where more oxygen is supplied. Therefore, distribution of the fuel in the fuel cell becomes non-uniform if power generation is continued without the circulatory supply of aqueous fuel solution. Such a non-uniform distribution of the fuel accelerates deterioration of the fuel cell, resulting in shortened life of the fuel cell.

Also, it is publicly known that in fuel cell systems in which aqueous fuel solution is circularly supplied, a liquid level adjusting unit maintains a liquid level in the aqueous solution container within a predetermined range. Since the aqueous fuel solution is consumed by the fuel cell, the liquid level in the aqueous solution container drops below the predetermined range if an abnormality occurs in the liquid level adjusting unit and it has become impossible to supply (replenish) water and fuel to the aqueous solution container. Normally, concentration adjustment of aqueous fuel solution is performed by supplying fuel to the aqueous solution container on an assumption that the liquid level is within the predetermined range. For this reason, when it becomes impossible to supply water to the aqueous solution container, fuel is supplied on the assumption that the liquid level is within the predetermined range despite the fact that the liquid level in the aqueous solution container is lower than the predetermined range. Therefore, the concentration of aqueous fuel solution in the aqueous solution container increases excessively, which results in unstable output from the fuel cell. Also, when it becomes impossible to supply fuel to the aqueous solution container due to an abnormality of the liquid level adjusting unit, the concentration of aqueous fuel solution decreases as power generation in the fuel cell continues, and as a result, output from the fuel cell decreases. As described, appropriate concentration adjustment becomes impossible, and normal power generation becomes unsustainable when an abnormality exists in the liquid level adjusting unit.

Further, when it becomes impossible to supply water and fuel to the aqueous solution container due to an abnormality of the liquid level adjusting unit, there is a risk that the aqueous solution container will become empty. The same risk exists when there is an abnormality, such as rupture, in the aqueous solution container. When the aqueous solution container becomes empty, it becomes impossible to circularly supply aqueous fuel solution, resulting in stoppage of power generation and deterioration of the fuel cell.

JP-A 2006-128012 discloses a fuel cell system in which water recovered by a condenser from exhaust gas is supplied to a tank by a recovery pump, and water held in the tank is supplied to the fuel cell by a supply pump. In the fuel cell system according to JP-A 2006-128012, measurement is made for a change in the amount of water held in the tank while the recovery pump is stopped and the supply pump is activated, and detection is performed for an abnormality in the supply pump based on the measured amount of change.

However, according to the technique disclosed in JP-A 2006-128012, it is impossible to detect abnormalities (such as water leak due to a breakage in a flow channel) which exist between the supply pump and the fuel cell. If such a technique according to JP-A 2006-128012 as described is applied to fuel cell systems in which aqueous fuel solution is circularly supplied, it is likely that the system is incapable of detecting abnormalities existing in the circulation unit.

Fuel cell systems in which aqueous fuel solution is circularly supplied require a plurality of detectors for detecting a flow amount of aqueous fuel solution and a flow pressure thereof, in order to detect abnormalities in the aqueous solution container, the circulation unit and the liquid level adjusting unit. For this reason, the conventional fuel systems have a complicated system configuration.

### SUMMARY OF THE INVENTION

In order to overcome the problems described above, preferred embodiments of the present invention provide a fuel cell system that is capable of easily detecting an abnormality in the aqueous solution container, the circulation unit or the liquid level adjusting unit.

According to a preferred embodiment of the present invention, a fuel cell system includes a fuel cell; an aqueous solution container arranged to hold aqueous fuel solution to be supplied to the fuel cell; a circulation unit arranged to circularly supply the aqueous fuel solution held in the aqueous solution container to the fuel cell; a liquid level detector arranged to detect a liquid level in the aqueous solution container; a liquid level adjusting unit arranged to make adjustments to maintain the liquid level in the aqueous solution container within a predetermined range based on a result of detection by the liquid level detector; and an abnormality detector arranged to detect an abnormality existing in the aqueous solution container, the circulation unit or the liquid level adjusting unit, based on a time-course change of the result of detection made by the liquid level detector.

According to a preferred embodiment of the present invention, comparison is made between an ongoing time-course change of the liquid level in the aqueous solution container and a normal-case time-course change of the liquid level in the aqueous solution container. If the aqueous solution container, the circulation unit and the liquid level adjusting unit are normal, there is a repeating cycle, in the aqueous solution container, of liquid level decrease caused by consumption of aqueous fuel solution in the fuel cell and liquid level increase caused by supply of water and fuel which is an operation performed by the liquid level adjusting unit. As a result, in normal cases, the liquid level in the aqueous solution container makes a cyclic change within a predetermined range. Therefore, it is easy to detect an abnormality existing in at least one of the aqueous solution container, the circulation unit and the liquid level adjusting unit, through comparison between the ongoing time-course change of the liquid level and the normal-case time-course change of the liquid level.

It should be noted here that an expression “to circularly supply aqueous fuel solution to the fuel cell” as used in the present invention means that the fuel cell is supplied with aqueous fuel solution which includes aqueous fuel solution that comes from the fuel cell.

Preferably, the liquid level detector detects that the liquid level in the aqueous solution container has reached either one of an upper limit and a lower limit of the predetermined range, whereas the abnormality detector detects the abnormality based on a result of comparison between a predetermined amount of time and a required time which is a time for the detection result provided by the liquid level detector to change from one to the other of the upper limit and the lower limit of the predetermined range. Since the liquid level in the aqueous solution container makes a cyclic up-and-down movement within the predetermined range in normal cases, it is possible to detect an abnormality through comparison between the required time which is an amount of time for the liquid level in the aqueous solution container to change from the upper limit to the lower limit of the predetermined range or vice versa, and the predetermined time which is established on the basis of a normal time-course change. If abnormality detection is made in such a way as described, the liquid level detector may be as simple as it should only be capable of detecting that the liquid level in the aqueous solution container has reached one of the upper limit and the lower limit of the predetermined range. This makes it possible to reduce cost of the system.

Preferably, the abnormality detector determines that an abnormality exists, if the required time, which is an amount of time for the liquid level in the aqueous solution container to change from the upper limit to the lower limit of the predetermined range or vice versa, has exceeded the predetermined time. In this case, the abnormality detector should only determine whether or not the required time has exceeded the predetermined time, making it simple to detect an abnormality.

According to another preferred embodiment of the present invention, a fuel cell system includes a fuel cell; an aqueous solution container arranged to hold aqueous fuel solution to be supplied to the fuel cell; a circulation unit arranged to circularly supply the aqueous fuel solution held in the aqueous solution container to the fuel cell; a liquid level detector arranged to detect a liquid level in the aqueous solution container; a liquid level adjusting unit arranged to make adjustments to maintain the liquid level in the aqueous solution container within a predetermined range based on a result of detection by the liquid level detector; and a stopping unit arranged to stop power generation in the fuel cell based on a time-course change of the result of detection made by the liquid level detector.

According to a preferred embodiment of the present invention, power generation in the fuel cell is stopped if the ongoing time-course change of the liquid level differs from the normal time-course change of the liquid level. In other words, power generation in the fuel cell is stopped if an abnormality exists in the aqueous solution container, the circulation unit or the liquid level adjusting unit and it is impossible for the fuel cell to continue normal power generation. This arrangement makes it possible to protect the fuel cell, and therefore, the fuel cell system.

According to another preferred embodiment of the present invention, a fuel cell system includes: a fuel cell; an aqueous solution container arranged to hold aqueous fuel solution to be supplied to the fuel cell; a circulation unit arranged to circularly supply the aqueous fuel solution held in the aqueous solution container to the fuel cell; a liquid level detector arranged to detect a liquid level in the aqueous solution container; a liquid level adjusting unit arranged to make adjustments to maintain the liquid level in the aqueous solution container within a predetermined range based on a result of detection by the liquid level detector; and a notification unit arranged to provide notification that an abnormality exists in the aqueous solution container, the circulation unit or the liquid level adjusting unit, based on a time-course change of the result of detection made by the liquid level detector.

According to a preferred embodiment of the present invention, it is possible to notify the fuel cell system user of an abnormality which exists in the aqueous solution container, the circulation unit or the liquid level adjusting unit if the ongoing time-course change of the liquid level differs from the normal time-course change of the liquid level. This arrangement provides the user, if it is impossible to continue normal power generation, with an opportunity to take some action such as stopping the power generation. This makes it possible to protect the fuel cell, and therefore, the fuel cell system.

As compared to fuel cell systems used in stationary equipment, fuel cell systems used in transportation equipment are more apt to develop abnormalities in the aqueous solution container, the circulation unit and the liquid level adjusting unit because of vibration, etc. during operation of the transportation equipment. According to the fuel cell system of preferred embodiments of the present invention, it is easy to detect an abnormality existing in the aqueous solution container, the circulation unit or the liquid level adjusting unit, and it is possible to protect the system reliably. Therefore, the fuel cell system according to various preferred embodiments of the present invention can be used suitably to transportation equipment.

The above-described and other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a left side view of a motorbike according to a preferred embodiment of the present invention.

FIG. 2 is a system diagram showing piping in a fuel cell system of a preferred embodiment of the present invention.

FIG. 3 is a block diagram showing an electric configuration of the fuel cell system according to a preferred embodiment of the present invention.

FIG. 4A through FIG. 4C are graphs showing time-course changes of a liquid level, a detection signal and an output in a normal case.

FIG. 5 is a flowchart showing an example of an operation of the fuel cell system according to a preferred embodiment of the present invention.

FIG. 6A through FIG. 6C are graphs showing an example of time-course changes of the liquid level, the detection signal and the output in case where a LOW time exceeds a first predetermined time.

FIG. 7A through FIG. 7C are graphs showing an example of time-course changes of the liquid level, the detection signal and the output in case where a HIGH time exceeds a second predetermined time.

### DETAILED DESCRIPTION OF THE PREFERRED EMBODIMENTS

Hereinafter, preferred embodiments of the present invention will be described, with reference to the drawings.

A fuel cell system 100 according to a preferred embodiment of the present invention is preferably provided in a motorbike 10 as an example of transportation equipment.

The description will first cover the motorbike 10. It is noted that the terms left and right, front and rear, up and down as used in the present preferred embodiment of the present invention are determined from the normal state of riding, i.e., as viewed by the driver sitting on the driver's seat of the motorbike 10, with the driver facing toward a handle 24.

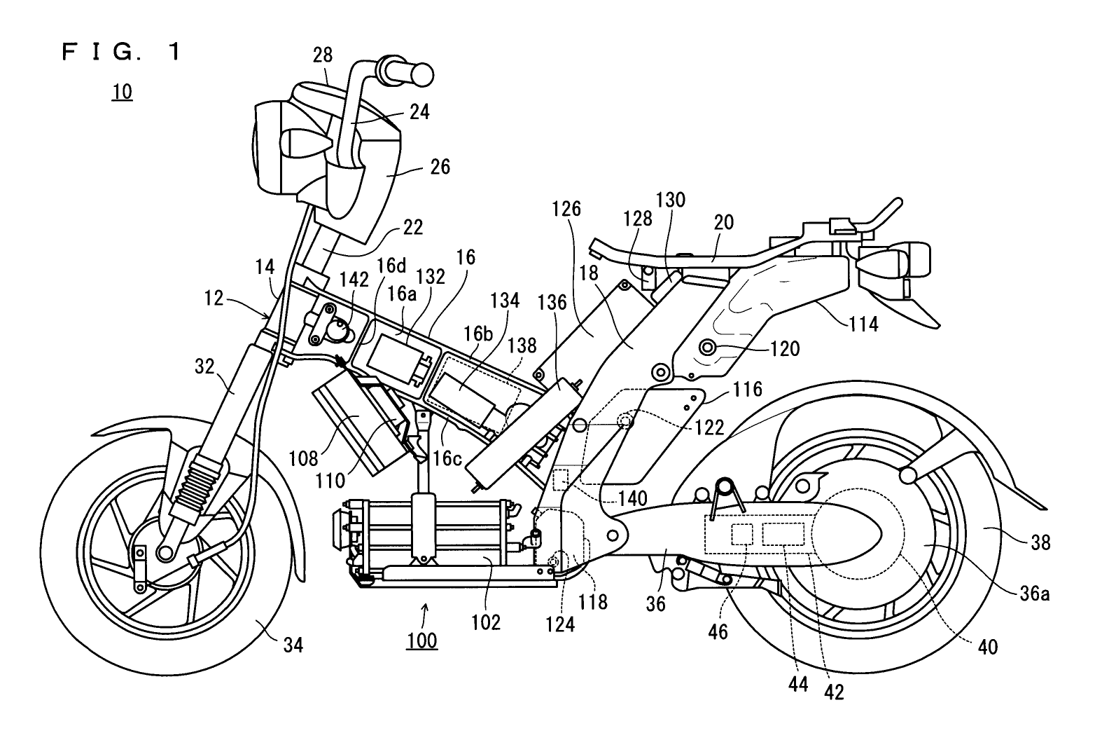

Referring to FIG. 1, the motorbike 10 preferably includes a vehicle frame 12. The vehicle frame 12 has a head pipe 14, a front frame 16 which has an I-shaped vertical section and extends in a rearward and downward direction from the head pipe 14, and a rear frame 18 which is connected with a rear end of the front frame 16 and rising in a rearward and upward direction.

The front frame 16 preferably includes a plate member 16a which has a width in the vertical direction and extends in a rearward and downward direction, substantially perpendicularly to the lateral directions of the vehicle; flanges 16b, 16c which are located respectively at an upper end edge and a lower end edge of the plate member 16a, and extending in a rearward and downward direction and have a width in the lateral directions; and reinforcing ribs 16d protruding from both surfaces of the plate member 16a. The reinforcing ribs 16d and the flanges 16b, 16c define storage walls, providing compartments on both surfaces of the plate member 16a defining storage spaces for components of the fuel cell system 100 to be described later.

The rear frame 18 preferably includes a pair of left and right plate members each having a width in the front and rear directions, extending in a rearward and upward direction, and sandwiching a rear end of the front frame 16. The pair of plate members of the rear frame 18 have their upper end portions provided with seat rails 20 fixed thereto, for installation of an unillustrated seat. Note that FIG. 1 shows the left plate member of the rear frame 18.

A steering shaft 22 is pivotably inserted in the head pipe 14. A handle support 26 is provided at an upper end of the steering shaft 22, to which the handle 24 is fixed. The handle support 26 has an upper end provided with a display/operation board 28.

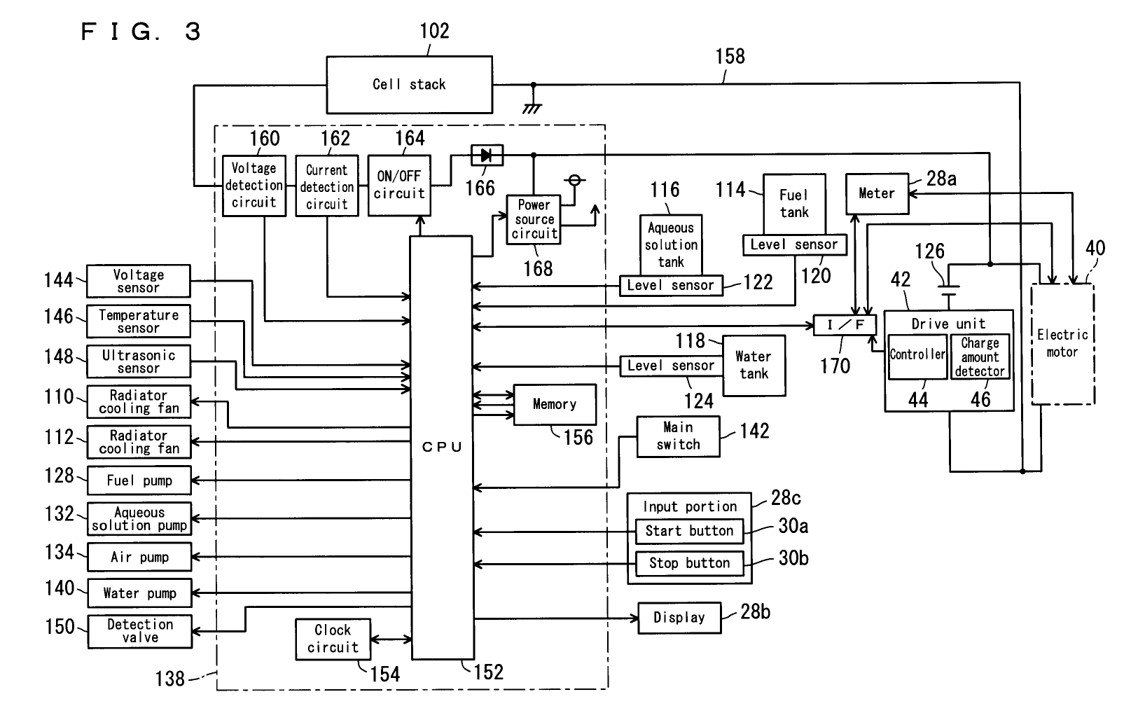

Referring also to FIG. 3, the display/operation board 28 preferably is an integrated dashboard including a meter 28a for measuring and displaying various data concerning an electric motor 40 (to be described later); a display 28b provided by, e.g., a liquid crystal display for providing the driver with a variety of information concerning the ride; and an input portion 28c for inputting a variety of commands and data. The input portion 28c includes a start button 30a for issuing a power generation start command of a fuel cell stack (hereinafter simply called cell stack) 102 and a stop button 30b for issuing a power generation stop command of the cell stack 102.

As shown in FIG. 1, a pair of left and right front forks 32 extend from a bottom end of the steering shaft 22. Each of the front forks 32 includes a bottom end supporting a front wheel 34 rotatably.

The rear frame 18 includes a lower end which pivotably supports a swing arm (rear arm) 36. The swing arm 36 has a rear end 36a incorporating the electric motor 40 of an axial gap type, for example, which is connected with the rear wheel 38 to rotate the rear wheel 38. The swing arm 36 also incorporates a drive unit 42 which is electrically connected with the electric motor 40. The drive unit 42 includes a motor controller 44 for controlling the rotating drive of the electric motor 40, and a charge amount detector 46 for detecting the amount of charge in the secondary battery 126 (to be described later).

The motorbike 10 as described is equipped with a fuel cell system 100, with its constituent members being disposed along the vehicle frame 12. The fuel cell system 100 generates electric energy for driving the electric motor 40 and other system components.

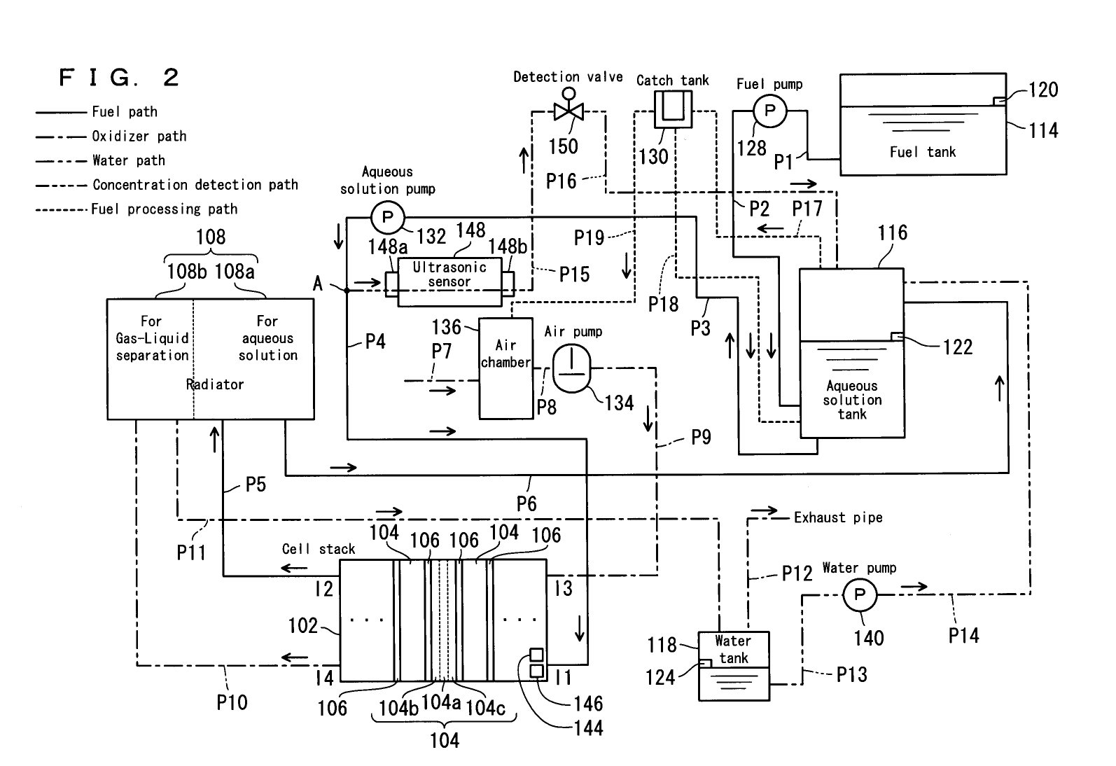

Hereinafter, the fuel cell system 100 will be described, with reference to FIG. 1 and FIG. 2.

The fuel cell system 100 is preferably a direct methanol fuel cell system which uses methanol (an aqueous solution of methanol) directly without reformation, for generation of electric energy (power generation).

The fuel cell system 100 includes the cell stack 102. As shown in FIG. 1, the cell stack 102 is suspended from the flange 16c, and is disposed below the front frame 16.

As shown in FIG. 2, the cell stack 102 includes a plurality of fuel cells (individual fuel cells) 104 layered (stacked) alternately with separators 106. Each fuel cell 104 is capable of generating electric power through electrochemical reactions between hydrogen ion based on methanol and oxygen. Each fuel cell 104 in the cell stack 102 includes an electrolyte film 104a, such as a solid polymer film, for example, and a pair of an anode (fuel electrode) 104b and a cathode (air electrode) 104c opposed to each other, with the electrolyte film 104a in between. The anode 104b and the cathode 104c are each connected with the electrolyte film 104a. The electrolyte film 104a, the anode 104b and the cathode 104c constitute an MEA (membrane electrode assembly). The anode 104b and the cathode 104c each include a platinum catalyst layer provided on the side closer to the electrolyte film 104a.

As shown in FIG. 1, a radiator unit 108 is disposed below the front frame 16, above the cell stack 102.

As shown in FIG. 2, the radiator unit 108 includes integrally therein, a radiator 108a for aqueous solution and a radiator 108b for gas-liquid separation. On a back side of the radiator unit 108, there is a fan 110 provided to cool the radiator 108a, and there is another fan 112 (See FIG. 3) provided to cool the radiator 108b. In FIG. 1, the radiators 108a and 108b are disposed side by side, with one on the left-hand side and the other on the right-hand side, and the figure shows the fan 110 for cooling the left-hand side radiator 108a.

A fuel tank 114, an aqueous solution tank 116 and a water tank 118 are disposed in this order from top to bottom, between the pair of plate members in the rear frame 18.

The fuel tank 114 contains a methanol fuel (high concentration aqueous solution of methanol) having a high concentration level (containing methanol at approximately 50 wt %, for example) which is used as fuel for the electrochemical reaction in the cell stack 102. The aqueous solution tank 116 contains aqueous methanol solution, which is a solution of the methanol fuel from the fuel tank 114 diluted to a suitable concentration (containing methanol at approximately 3 wt %, for example) for the electrochemical reaction in the cell stack 102. The water tank 118 contains water which is produced in association with the electrochemical reaction in the cell stack 102.

The fuel tank 114 is provided with a level sensor 120 while the aqueous solution tank 116 is provided with a level sensor 122, and the water tank 118 is provided with a level sensor 124. The level sensors 120, 122 and 124 are float sensors each having an unillustrated float, for example, in order to detect the height of liquid (liquid level) in the respective tanks by the position of the moving float.

In front of the fuel tank 114 and above the front frame 16 is the secondary battery 126. The secondary battery 126 stores the electric power from the cell stack 102, and supplies the electric power to the electric components in response to commands from a controller 138 (to be described later). Above the secondary battery 126, a fuel pump 128 is disposed. Further, a catch tank 130 is disposed in front of the fuel tank 114, i.e., above and behind the secondary battery 126.

An aqueous solution pump 132 and an air pump 134 are housed in the storage space on the left side of the front frame 16. On the left side of the air pump 134 is an air chamber 136. The controller 138 and a water pump 140 are disposed in the storage space on the right side of the front frame 16.

Further, a main switch 142 is provided in the front frame 16, penetrating the storage space in the front frame 16 from right to left. Turning on the main switch 142 provides an operation start command to the controller 138 and turning off the main switch 142 provides an operation stop command to the controller 138.

As shown in FIG. 2, the fuel tank 114 and the fuel pump 128 are connected with each other by a pipe P1. The fuel pump 128 and the aqueous solution tank 116 are connected with each other by a pipe P2. The aqueous solution tank 116 and the aqueous solution pump 132 are connected with each other by a pipe P3. The aqueous solution pump 132 and the cell stack 102 are connected with each other by a pipe P4. The pipe P4 is connected with an anode inlet I1 of the cell stack 102. By driving the aqueous solution pump 132, aqueous methanol solution is supplied to the cell stack 102.

A voltage sensor 144 is provided near the anode inlet I1 of the cell stack 102 in order to detect concentration information, which reflects the concentration of aqueous methanol solution (the ratio of methanol in the aqueous methanol solution) supplied to the cell stack 102, using an electrochemical characteristic of the aqueous methanol solution. The voltage sensor 144 detects an open-circuit voltage of the fuel cell 104, and the detected voltage value defines electrochemical concentration information. Based on the concentration information, the controller 138 detects the concentration of the aqueous methanol solution supplied to the cell stack 102. Near the anode inlet I1 of the cell stack 102, a temperature sensor 146 is provided in order to detect the temperature of aqueous methanol solution supplied to the cell stack 102.

The cell stack 102 and the aqueous solution radiator 108a are connected with each other by a pipe P5, and the radiator 108a and the aqueous solution tank 116 are connected with each other by a pipe P6. The pipe P5 is connected with an anode outlet I2 of the cell stack 102.

The pipes P1 through P6 serve primarily as a flow path for fuel.

A pipe P7 is connected with the air chamber 136. The air chamber 136 and the air pump 134 are connected with each other by a pipe P8 whereas the air pump 134 and the fuel cell stack 102 are connected with each other by a pipe P9. The pipe P9 is connected with a cathode inlet i3 of the cell stack 102. By driving the air pump 134, air from outside is supplied to the cell stack 102.

The cell stack 102 and the gas-liquid separation radiator 108b are connected with each other by a pipe P10. The radiator 108b and the water tank 118 are connected with each other by a pipe P11. The water tank 118 is provided with a pipe (an exhaust pipe) P12. The pipe P12 is provided at an exhaust discharge outlet of the water tank 118, and discharges exhaust gas from the cell stack 102 to outside.

The pipes P7 through P12 serve primarily as a flow path for oxidizer.

The water tank 118 and the water pump 140 are connected with each other by a pipe P13 whereas the water pump 140 and the aqueous solution tank 116 are connected with each other by a pipe P14.

The pipes P13, P14 serve as a flow path for water.

Also, a pipe P15 is connected with a branching section A of the pipe P4 so that part of aqueous methanol solution which flows through the pipe P4 will flow in. An ultrasonic sensor 148 is attached to the pipe P15. The ultrasonic sensor 148 is arranged to detect the methanol concentration of aqueous methanol solution, based on the principle that a travel time (propagation speed) of ultrasonic waves changes depending on the concentration. The ultrasonic sensor 148 includes a transmitter unit 148a and a receiver unit 148b. An ultrasonic wave transmitted from the transmitter unit 148a is received by the receiver unit 148b to detect an ultrasonic wave travel time in the pipe P15, and a voltage value which corresponds to the travel time is taken as physical concentration information. The controller 138 detects the concentration of the aqueous methanol solution in the pipe P15 based on the concentration information.

A detection valve 150 is connected with the pipe P15. The detection valve 150 and the aqueous solution tank 116 are connected with each other by a pipe P16. When detecting the concentration, the detection valve 150 is closed to stop the flow of aqueous methanol solution in the pipe P15. After the detection of the concentration, the detection valve 150 is opened to release the aqueous methanol solution, whose concentration has been detected, back to the aqueous solution tank 116.

The pipes P15, P16 serve as a flow path for concentration detection.

The aqueous solution tank 116 and the catch tank 130 are connected with each other by pipes P17, P18. The catch tank 130 and the air chamber 136 are connected with each other by a pipe P19.

The pipes P17 through P19 constitute a flow path for fuel processing.

Next, reference will be made to FIG. 3, to cover an electrical configuration of the fuel cell system 100.

The controller 138 of the fuel cell system 100 preferably includes a CPU 152 for performing necessary calculations and controlling operations of the fuel cell system 100; a clock circuit 154 which gives the CPU 152 a clock signal for use in time measurement, etc; a memory 156 provided by, e.g., an EEPROM for storing programs and data for controlling the operations of the fuel cell system 100 as well as calculation data, etc.; a voltage detection circuit 160 for detecting a voltage in an electric circuit 158 to connect the cell stack 102 with an electric motor 40 which drives the motorbike 10; an electric current detection circuit 162 for detecting an electric current which passes through the fuel cells 104, i.e., the cell stack 102; an ON/OFF circuit 164 for opening and closing the electric circuit 158; a diode 166 provided in the electric circuit 158; and a power source circuit 168 for providing the electric circuit 158 with a predetermined voltage.

The CPU 152 of the controller 138 as described above is supplied with detection signals from the level sensors 120, 122 and 124, and detection signals from the voltage sensor 144, the temperature sensor 146, the ultrasonic sensor 148 and the charge amount detector 46.

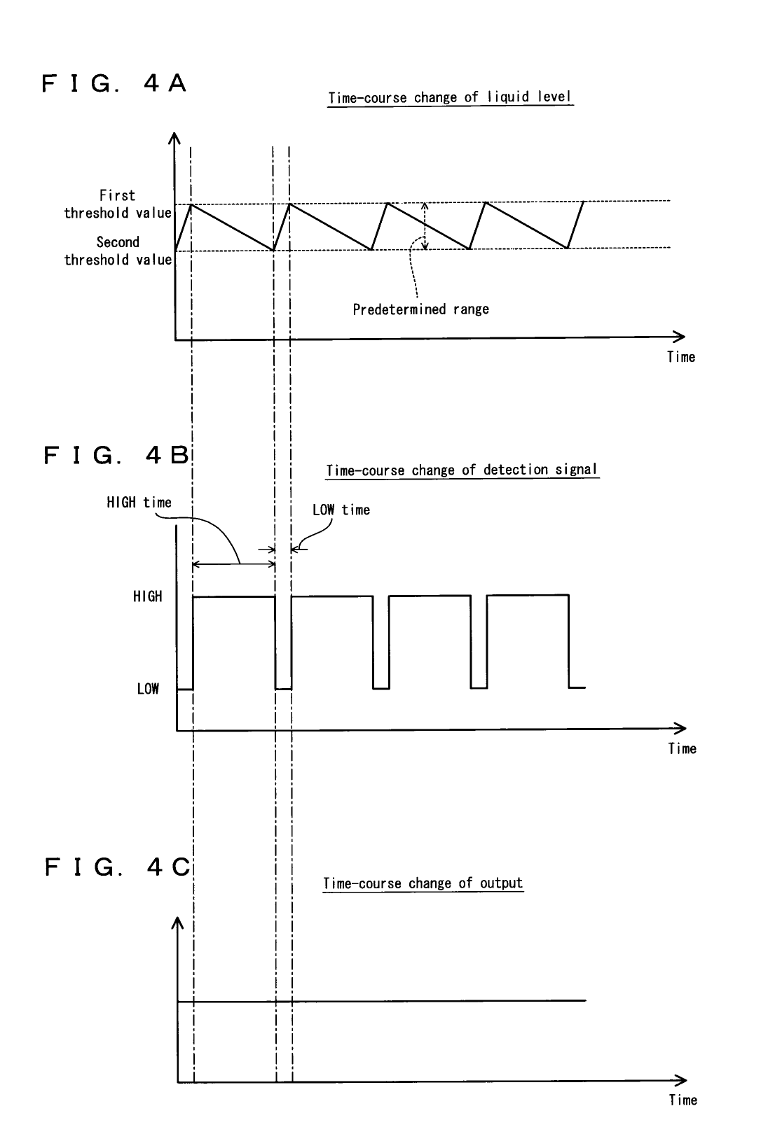

Referring also FIG. 4A and FIG. 4B, a level sensor 122 for example, inputs a detection signal HIGH to the CPU 152 until the liquid level in the aqueous solution tank 116 decreases from an upper limit (first threshold value) to a lower limit (second threshold value) of a predetermined range, whereas it inputs a detection signal LOW to the CPU 152 until the liquid level in the aqueous solution tank 116 increases from the second threshold value to the first threshold value. With this arrangement, the CPU 152 detects that the liquid level in the aqueous solution tank 116 has reached the second threshold value from the first threshold value, and that the liquid level in the aqueous solution tank 116 has reached the first threshold value from the second threshold value.

The CPU 152 is also supplied with input signals from the main switch 142 for turning ON or OFF the electric power, and input signals from the start button 30a and the stop button 30b in the input portion 28c.

Further, the CPU 152 is supplied with voltage values detected by the voltage detection circuit 160 and electric current values detected by the electric current detection circuit 162. The CPU 152 calculates an output from the cell stack 102, using the voltage values and electric current values supplied.

The CPU 152 controls system components such as the fuel pump 128, the aqueous solution pump 132, the air pump 134, the water pump 140, the detection valve 150 and the fans 110, 112. For example, the aqueous solution pump 132 and the water pump 140 are each controlled by the CPU 152 so that their output (the amount of liquid pumped per unit time) will be constant. Further, the CPU 152 controls the display 28b which displays various kinds of information for the driver of the motorbike 10.

The cell stack 102 is connected with the secondary battery 126 and the drive unit 42. The secondary battery 126 and the drive unit 42 are connected with the electric motor 40. The secondary battery 126 complements the output from the cell stack 102, by being charged with electric power from the cell stack 102 and discharging the electricity to supply power to the electric motor 40, the system components, etc.

The electric motor 40 is connected with the meter 28a for measuring various data concerning the electric motor 40. The data and status information of the electric motor 40 obtained by the meter 28a are supplied to the CPU 152 via the interface circuit 170.

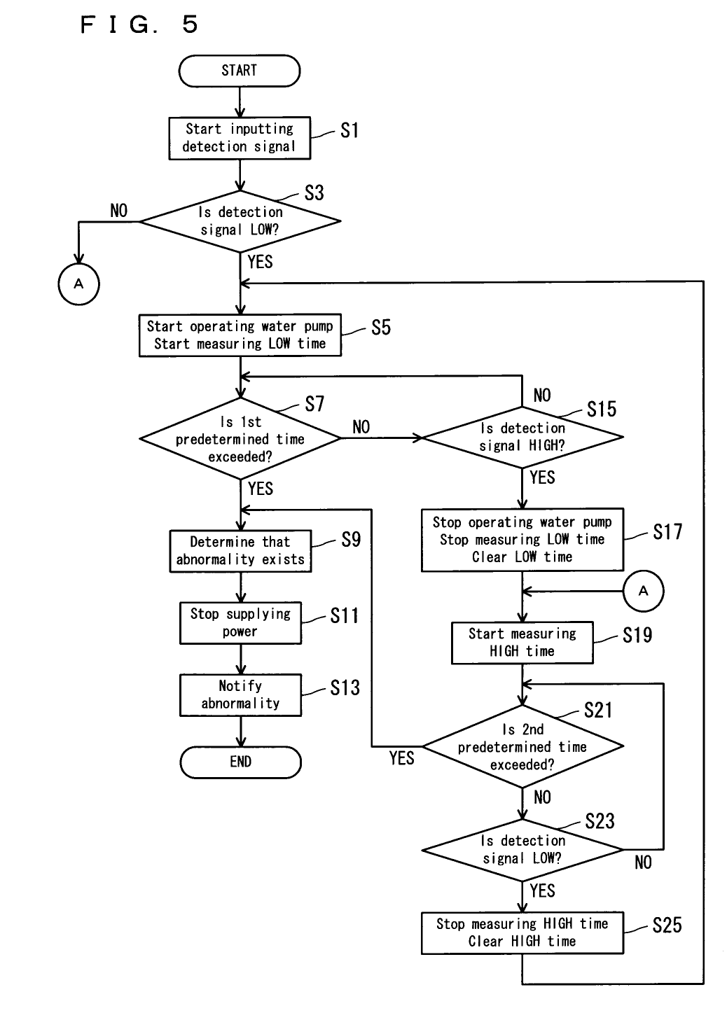

The memory 156 stores programs for performing operations shown in FIG. 5, the first and the second predetermined time values, calculation data, etc.

In the present preferred embodiment, the aqueous solution tank 116 defines the aqueous solution container. The liquid level detection unit includes the level sensor 122. The circulation unit includes the radiator 108a, the aqueous solution pump 132 and the pipes P3 through P6. The liquid level adjusting unit includes the water tank 118, the water pump 140, the CPU 152 and the pipes P13, P14. The notification unit includes the display portion 28b and the CPU 152. The CPU 152 also functions as the abnormality detector and the stopping unit.

The fuel supply unit arranged to supply the aqueous solution tank 116 with methanol fuel from the fuel tank 114 which defines the fuel container is constituted by the fuel pump 128 and the pipes P1, P2. The water supply unit arranged to supply the aqueous solution tank 116 with water from the water tank 118 which defines the water container is constituted by the water pump 140 and the pipes P13, P14. It should be noted here that the fuel supply unit at least includes the fuel pump 128, and the water supply unit at least includes the water pump 140. Further, the time measurement unit for measuring a required time (LOW time), i.e., the amount of time for the detection signal from the level sensor 122 to change from LOW to HIGH, and a required time (HIGH time), i.e., the amount of time for the detection signal from the level sensor 122 to change from HIGH to LOW, is constituted by the CPU 152 and the clock circuit 154.

Next, description will cover a basic operation of the fuel cell system 100.

When the main switch 142 is turned on, the fuel cell system 100 starts the controller 138 and commences its operation. After the controller 138 is started, and when the start button 30a is pressed, system components such as the aqueous solution pump 132 and the air pump 134 are started using electricity from the secondary battery 126, and thus power generation in the cell stack 102 is started.

Referring to FIG. 2, aqueous methanol solution in the aqueous solution tank 116 is pumped by the aqueous solution pump 132, and is supplied directly to the anode 104b in each of the fuel cells 104 which constitute the cell stack 102, via the pipes P3, P4, an unillustrated aqueous solution filter and the anode inlet I1.

Meanwhile, gas (primarily containing carbon dioxide, vaporized methanol and water vapor) in the aqueous solution tank 116 is supplied via the pipe P17 to the catch tank 130. The methanol vapor and water vapor are cooled in the catch tank 130, and the aqueous methanol solution obtained in the catch tank 130 is returned via the pipe P18 to the aqueous solution tank 116. On the other hand, gas (containing carbon dioxide, non-liquefied methanol and water vapor) in the catch tank 130 is supplied via the pipe P19 to the air chamber 136.

Air which is introduced by the air pump 134 via the pipes P7 and an unillustrated air filter enters an air chamber 136, where it is silenced. The air which was introduced to the air chamber 136 and gas from the catch tank 130 flow via the pipe P8 to the air pump 134, and then through the pipe P9 and the cathode inlet I3, into the cathode 104c in each of the fuel cells 104 which constitute the cell stack 102.

At the anode 104b in each fuel cell 104, methanol and water in the supplied aqueous methanol solution chemically react with each other to produce carbon dioxide and hydrogen ions. The produced hydrogen ions flow to the cathode 104c via the electrolyte film 104a, and electrochemically react with oxygen in the air supplied to the cathode 104c, to produce water (water vapor) and electric energy. Thus, power generation is performed in the cell stack 102. The electricity from the cell stack 102 is used to charge the secondary battery 126, to drive the motorbike 10 and so on.

The temperature of the cell stack 102 is increased by heat from the electrochemical reactions. The output from the cell stack 102 increases as the temperature increases. The fuel cell system 100 attains a state of normal operation where it can generate electric power constantly, when the cell stack 102 has attained a temperature of about 50° C., for example. The temperature of the cell stack 102 can be checked by the temperature of aqueous methanol solution detected by the temperature sensor 146.

Carbon dioxide produced at the anode 104b of each fuel cell 104, and aqueous methanol solution including unused methanol are heated by the heat from the electrochemical reactions. The carbon dioxide and the aqueous methanol solution flow from the anode outlet I2 of the cell stack 102, through the pipe P5 into the radiator 108a, where they are cooled. The cooling of the carbon dioxide and the methanol is facilitated by driving the fan 110. The carbon dioxide and the aqueous methanol solution which have been cooled then flow through the pipe P6, and return to the aqueous solution tank 116.

In other words, aqueous methanol solution held in the aqueous solution tank 116 is circularly supplied to the cell stack 102 by the operation of the aqueous solution pump 132.

During the power generation, bubbles are formed in aqueous methanol solution in the aqueous solution tank 116 due to circulation flow of aqueous methanol solution from the cell stack 102, an incoming flow of the carbon dioxide from the cell stack 102, etc., and thus the float of the level sensor 122 is raised by an amount corresponding to the amount of bubbles.

Meanwhile, most of the water vapor produced on the cathode 104c in each fuel cell 104 is liquefied and discharged in the form of water from the cathode outlet I4 of the cell stack 102, with saturated water vapor being discharged in the form of gas. The water vapor which was discharged from the cathode outlet I4 is supplied via the pipe P10 to the radiator 108b, where it is cooled and its portion is liquefied as its temperature decreases to or below the dew point. The liquefying operation of the water vapor by the radiator 108b is facilitated by operation of the fan 112. Discharge from the cathode outlet I4, which contains water (liquid water and water vapor), carbon dioxide and unused air, is supplied via the pipe P10, the radiator 108b and the pipe P11, to the water tank 118 where water is collected, and thereafter, discharged to outside via the pipe P12.

At the cathode 104c in each fuel cell 104, the vaporized methanol from the catch tank 130 and methanol which has moved to the cathode 104c due to crossover react with oxygen in the platinum catalyst layer, thereby being decomposed to harmless substances of water and carbon dioxide. The water and carbon dioxide which are produced from the methanol are discharged from the cathode outlet I4, and supplied to the water tank 118 via the radiator 108b. Further, water which has moved due to water crossover to the cathode 104c in each fuel cell 104 is discharged from the cathode outlet I4, and supplied to the water tank 118 via the radiator 108b.

Water in the water tank 118 is supplied appropriately to the aqueous solution tank 116 by the operation of the water pump 140, via the pipes P13, P14. The water pump 140 is controlled by the CPU 152 based on the detection signal from the level sensor 122, so that the liquid level in the aqueous solution tank 116 will be maintained within the predetermined range.

It should be noted here that the level sensor 122 enters the detection signal HIGH to the CPU 152 as an initial value if the liquid level in the aqueous solution tank 116 is not lower than the first threshold value (See FIG. 4A) when the sensor operation is started (when power generation is started, according to the present example). Then, when the liquid level in the aqueous solution tank 116 has decreased to the second threshold value (See FIG. 4A), the level sensor 122 changes its detection signal which is entered into the CPU 152, from the initial value, i.e., HIGH, to LOW. On the other hand, if the liquid level in the aqueous solution tank 116 is lower than the first threshold value when the sensor operation is started, the level sensor 122 enters the detection signal LOW to the CPU 152 as the initial value, and then, the level sensor 122 changes its detection signal entered into the CPU 152, from the initial value, i.e., LOW, to HIGH when the liquid level in the aqueous solution tank 116 has increased to the first threshold value. After changing the detection signal from the initial value, the level sensor 122 operates as described above, changing the detection signal from one to the other, i.e., from HIGH to LOW or vice versa, according to the change in the liquid level in the aqueous solution tank 116.

Now, reference will be made here to FIG. 4A and FIG. 4B, to describe time-course changes of the liquid level in the aqueous solution tank 116, and of the detection signal of the level sensor 122 in a normal case. In this description, the output from the cell stack 102 is constant as shown in FIG. 4C. In other words, the amount of consumption of aqueous methanol solution in the cell stack 102 is constant, and the rate of decrease in the liquid level in the aqueous solution tank 116 is constant.

As shown in FIG. 4A, when the liquid level in the aqueous solution tank 116 has decreased from the first threshold value (the upper limit in the predetermined range) to the second threshold value (the lower limit in the predetermined range), the detection signal of the level sensor 122 changes as shown in FIG. 4B, from HIGH to LOW. In response to this, the CPU 152 causes the water pump 140 to start supplying (replenishing) water to the aqueous solution tank 116.

After starting the supply of water, when the liquid level in the aqueous solution tank 116 increases from the second threshold value to the first threshold value as shown in FIG. 4A, the detection signal of the level sensor 122 changes from LOW to HIGH as shown in FIG. 4B. In response to this, the CPU 152 causes the water pump 140 to stop the supply of water to the aqueous solution tank 116. As a result, the liquid level in the aqueous solution tank 116 begins to decrease from the first threshold value, again. As the level of aqueous methanol solution in the aqueous solution tank 116 repeats this pattern of increase and decrease, the liquid level in the aqueous solution tank 116 makes a cyclical change (up-and-down movement) between the first threshold value and the second threshold value (in the predetermined range) (See FIG. 4A).

A required time, i.e., an amount of time for the liquid level in the aqueous solution tank 116 to decrease from the first threshold value to the second threshold value due to the consumption of aqueous methanol solution by the cell stack 102, is approximately 10 seconds, for example. In other words, the required time (HIGH time), which is an amount of time before the detection signal input to the CPU 152 is changed from HIGH to LOW, is approximately 10 seconds, for example.

A required time, i.e., an amount of time for the liquid level in the aqueous solution tank 116 to increase from the second threshold value to the first threshold value due to the supply of water is approximately 2 seconds, for example. In other words, the required time (LOW time), which is an amount of time before the detection signal input to the CPU 152 is changed from LOW to HIGH, is approximately 2 seconds, for example. As the aqueous solution pump 132 is stopped, i.e., when the circulatory supply of aqueous methanol solution is stopped, bubbles which are present in the aqueous methanol solution in the aqueous solution tank 116 disappear, and the liquid level in the aqueous solution tank 116 decreases. As a result of this, if the level at the time of stopping circulatory supply is the second threshold value, there is a large decrease in the liquid level after the stoppage of the circulatory supply from the second threshold value, and the LOW time in the next start of circulatory supply (start of power generation) becomes the longest (approximately 6 seconds, for example) of normally assumable LOW times.

It should be noted here that since the output from the aqueous solution pump 132 and the output from water pump 140 are constant, and since the amount of consumption of aqueous methanol solution varies only slightly due to operational conditions (power generation conditions), the liquid level and the detection signal change generally as shown in FIG. 4A and FIG. 4B regardless of the operating conditions.

It should also be noted that in actual operation, methanol fuel is supplied to the aqueous solution tank 116 at a predetermined interval as will be described later. However, FIG. 4A does not show this because the amount of supply of the methanol fuel is small enough to make a noticeable difference in the liquid level in the aqueous solution tank 116.

Returning to FIG. 2, methanol fuel in the fuel tank 114 is supplied appropriately to the aqueous solution tank 116 via the pipes P1, P2 by a pumping operation of the fuel pump 128. The fuel pump 128 is controlled by the CPU 152 based on the concentration of aqueous methanol solution detected by a voltage sensor 144 or an ultrasonic sensor 148. Specifically, the CPU 152 causes the fuel pump 128 to supply methanol fuel so that aqueous methanol solution in the aqueous solution tank 116 will have a concentration (for example, about 3 wt. %) that is suitable for power generation based on a result of the concentration detection, based on an assumption, e.g., that the liquid level is at the second threshold value. In other words, the CPU 152 makes the fuel pump 128 supply methanol fuel based on a result of the concentration detection, on an assumption that there is a predetermined amount of aqueous methanol solution held in the aqueous solution tank 116. Such a concentration adjustment is performed every five seconds, for example. Since the target concentration of the aqueous methanol solution is about 3 wt. %, for example, the amount of methanol fuel supplied to the aqueous solution tank 116 in the concentration adjustment is significantly smaller than the amount of liquid in the aqueous solution tank 116.

The fuel cell system 100 as described above detects, based on the HIGH time and the LOW time, an abnormality which can exist in any of the aqueous solution tank 116 which defines the aqueous solution container, the circulation unit which includes the radiator 108a, the aqueous solution pump 132 and the pipes P3 through P6, and the liquid level adjusting unit which includes the water tank 118, the water pump 140 and the pipes P13, P14.

Next, reference will be made to FIG. 5 to describe an example of operation of the fuel cell system 100.

First, as the start button 30a is pressed, system components such as the aqueous solution pump 132 and the air pump 134 are started, and power generation is started. At the same time, input of detection signal from the level sensor 122 to the CPU 152 is started (Step S1).

In Step S1, if the liquid level in the aqueous solution tank 116 is lower than the first threshold value (See FIG. 4A), inputting to the CPU 152 of the detection signal LOW, which indicates that it is necessary to increase the liquid level, is started. On the other hand, if the liquid level in the aqueous solution tank 116 is not lower than the first threshold value, inputting to the CPU 152 of the detection signal HIGH, which indicates that it is not necessary to increase the liquid level, is started. Then, in Step S3, if the CPU 152 has an input of the detection signal LOW, the CPU 152 starts operation of the water pump 140, and starts measuring the LOW time based on the clock signal from the clock circuit 154 (Step S5).

Subsequently, the CPU 152 starts comparison between the LOW time and the first predetermined time which is a value stored in the memory 156 in advance, to determine on whether or not the LOW time has exceeded the first predetermined time (Step S7). The first predetermined time is longer than the longest assumable LOW time (six seconds) in normal operation. In this example, the first predetermined time is set to seven seconds.

If, for example, a failure of the water pump 140 or breakage in the water tank 118 or in the pipes P13, P14 has made it impossible to supply (replenish) water to the aqueous solution tank 116, the LOW time will exceed the first predetermined time. As described earlier, methanol fuel is supplied to the aqueous solution tank 116 based on the assumption that the liquid level in the aqueous solution tank 116 is the second threshold value, and thus, if it becomes impossible to replenish water to the aqueous solution tank 116, the concentration of the aqueous methanol solution becomes too high. In other words, it becomes impossible to perform appropriate concentration adjustment. Further, the aqueous solution tank 116 will become empty eventually, making it impossible to continue the circulatory supply of aqueous methanol solution. If circulatory supply of aqueous methanol solution is stopped during power generation (while the air pump 134 is in operation), power generation is continued for some time, using aqueous methanol solution left in the cell stack 102. However, after a lapse of approximately thirty seconds from the stoppage of circulatory supply, methanol consumption progresses to an extent where the output from the cell stack 102 begins to drop, and eventually, power generation stops. In the individual fuel cell 104, oxygen is supplied non-uniformly to the cathode 104c. Therefore, if power generation is continued while circulatory supply of aqueous methanol solution is stopped, methanol consumption in the anode 104b increases at regions which correspond to regions of the cathode 104c where more oxygen is supplied. Under this situation, by the time when the output from the cell stack 102 begins to drop, distribution of methanol is non-uniform in the MEA of the fuel cell 104. Non-uniform distribution of methanol accelerates deterioration of the MEA, i.e., the fuel cell 104, resulting in shortened life of the cell stack 102. Likewise, in each of the fuel cells 104 which constitute the cell stack 102, the amount of oxygen supplied to each cathode 104c is not uniform. Therefore, the extent of deterioration differs from one fuel cell 104 to another.

If the LOW time has exceeded the first predetermined time in Step S7, the CPU 152 determines that an abnormality exists (Step S9), and stops power supply to the system components (Step S11). In other words, the CPU 152 detects, based on a result of comparison between the LOW time and the first predetermined time, that an abnormality exists in the radiator 108a, the aqueous solution tank 116, the water tank 118, the aqueous solution pump 132, the water pump 140 or pipes P3 through P6, P13, and P14. The CPU 152 determines that an abnormality exists if the LOW time has exceeded the first predetermined time. In this case, the CPU 152 forcibly stops the operation of system components because of the risk of deterioration of the fuel cell 104 caused by inability to continue power generation (normal power generation). With this arrangement, power generation in the cell stack 102 is stopped forcibly, making it possible to reduce deterioration of the fuel cell 104, and to protect the fuel cell system 100.

Thereafter, the CPU 152 causes the display portion 28b to display a message, etc., thereby notifying the user of the fuel cell system 100 (the driver of the motorbike 10 in this preferred embodiment) of an abnormality (Step S13), and the operation comes to an end.

On the other hand, if the detection signal inputted to the CPU 152 is changed from LOW to HIGH in Step S15 before the LOW time has exceeded the first predetermined time in Step S7, then the CPU 152 stops operation of the water pump 140 while stopping the measurement of the LOW time and clearing the LOW time (Step S17). Then, the CPU 152 starts measurement of the HIGH time (Step S19).

Subsequently, the CPU 152 starts comparison between the HIGH time and the second predetermined time which is a value stored in the memory 156 in advance, to determine on whether or not the HIGH time has exceeded the second predetermined time (Step S21). The second predetermined time is longer than the normal HIGH time (about ten seconds, for example) but is shorter than a period of time (about thirty seconds, for example, in the present preferred embodiment) from the stoppage of the circulatory supply during power generation to the decrease of the output from the cell stack 102. In the present preferred embodiment, the second predetermined time is set to about eleven seconds, for example. As has been described, by the time the output from the cell stack 102 begins to decrease after stoppage of circulatory supply, methanol distribution in the MEA of the fuel cell 104 is non-uniform, and under this situation, deterioration of the fuel cell 104 is accelerated. In order to prevent this, the second predetermined time is shorter than an amount of time before the cell stack 102 decreases its output following a stoppage of circulatory supply.

If circulatory supply of aqueous methanol solution is stopped during power generation by a failure of the aqueous solution pump 132, for example, the liquid level in the aqueous solution tank 116 no longer decreases, and the HIGH time exceeds the second predetermined time. In this case, since circulatory supply of aqueous methanol solution has been stopped, an anticipated result is stoppage of power generation and deterioration of the fuel cell 104.

Therefore, if the HIGH time has exceeded the second predetermined time in Step S21, it is determined that an abnormality exists, and the process moves to Step S9, where the system components are stopped forcibly.

On the other hand, if the detection signal inputted to the CPU 152 is changed from HIGH to LOW in Step S23 before the second predetermined time is exceeded in Step S21, then the CPU 152 stops measurement of the HIGH time, and clears the HIGH time (Step S25). Thereafter, the process returns to Step S5.

Also, the process returns to Step S7 until the detection signal becomes HIGH in Step S15. The process returns to Step S21 until the detection signal becomes LOW in Step S23. The process moves to Step S19 if the detection signal inputted in the CPU 152 in Step S3 is HIGH.

It should be noted here that after Step S9, one of Step S11 and S13 may be performed. In other words, after it is determined that continued normal power generation may no longer be possible, the system may either stop power supply to the system components or notify the driver of the abnormality.

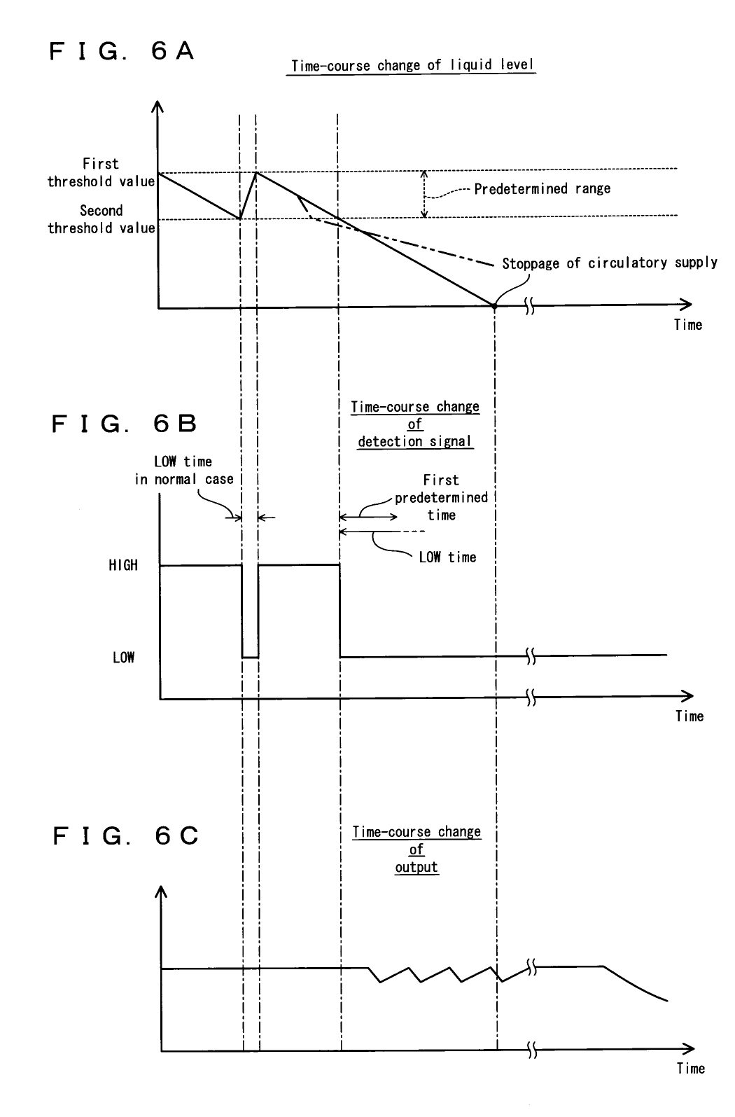

Next, reference will be made to FIG. 6A and FIG. 6B, to describe an example of time-course changes of the liquid level and the detection signal in the case where the LOW time exceeds the first predetermined time. FIGS. 6A and FIG. 6 show time-course changes in a case where it becomes impossible to supply water to the aqueous solution tank 116 due to a failure of the water pump 140.

As shown in FIG. 6A, if it becomes impossible to supply water to the aqueous solution tank 116, the liquid level in the aqueous solution tank 116 continues to decrease as the cell stack 102 consumes aqueous methanol solution. As a result, as shown in FIG. 6B, the LOW time exceeds the first predetermined time.

When it becomes impossible to supply water as described above, it becomes impossible to perform appropriate concentration adjustment as described earlier, and the output from the cell stack 102 becomes unstable. Specifically, as will be understood from FIG. 6C, methanol fuel which is supplied in the concentration adjustment makes the concentration of aqueous methanol solution too high, decreasing the output from the cell stack 102. The output from the cell stack 102 increases as the concentration of aqueous methanol solution decreases (comes closer to 3 wt. %) due to power generation. However, since the aqueous solution tank 116 is supplied with methanol fuel again, the output from the cell stack 102 decreases. As described, the output from the cell stack 102 becomes unstable when it becomes impossible to supply water to the aqueous solution tank 116.

Further, when it becomes impossible to supply water to the aqueous solution tank 116, the aqueous solution tank 116 becomes empty eventually, making it impossible to continue the circulatory supply of aqueous methanol solution. If circulatory supply is stopped during power generation, power generation in the cell stack 102 is continued for some time, by using aqueous methanol solution which exists in the anode 104b of each cell stack 102. However, after a lapse of approximately thirty seconds, for example, from the stoppage of circulatory supply, methanol consumption at the anode 104b reaches an extent where the output from the cell stack 102 begins to drop (See FIG. 6C). As has been described, by the time when the output from the cell stack 102 begins to drop, distribution of methanol is non-uniform in the MEA of the fuel cell 104, and this situation accelerates deterioration of the fuel cell 104. As a result, life of the cell stack 102 is shortened.

It is also likely that the LOW time exceeds the first predetermined time even if the water tank 118, the water pump 140 and the pipes P13, P14 are all normal. For example, there can be a case where at least one of the radiator 108a, the aqueous solution tank 116, the aqueous solution pump 132 and the pipes P3 through P6 is broken to cause aqueous methanol solution to leak outside. FIG. 6A shows an example of time-course change of the liquid level in this case, in two-dot chain lines. Under this situation, the rate of decrease in the liquid level in the aqueous solution tank 116 becomes greater than in the normal case, i.e., the liquid level reaches the second threshold value in a shorter time. Once the liquid level reaches the second threshold value, supply of water is started and the rate of decrease in the liquid level becomes smaller. However, if the amount of decrease in the aqueous methanol solution is greater than the amount of water supply, it is impossible to increase the liquid level, and therefore the LOW time will exceeds the first predetermined time. In this case again, it becomes impossible to provide appropriate concentration adjustment. Further, the aqueous solution tank 116 becomes empty eventually, resulting in stoppage of circulatory supply, leading to stoppage of power generation and to deterioration of the fuel cell 104.

Beside these cases, there can be a case, for example, where the amount of decrease in aqueous methanol solution and the amount of water supply become substantially equal to each other due to an abnormality. In this case again, it becomes impossible to bring the liquid level in the aqueous solution tank 116 to the first threshold value, and thus the LOW time exceeds the first predetermined time.

As has been described, there can be various cases where the LOW time exceeds the first predetermined time. In any of the cases, an abnormality exists in the radiator 108a, the aqueous solution tank 116, the water tank 118, the aqueous solution pump 132, the water pump 140 or the pipes P3 through P6, P13, P14.

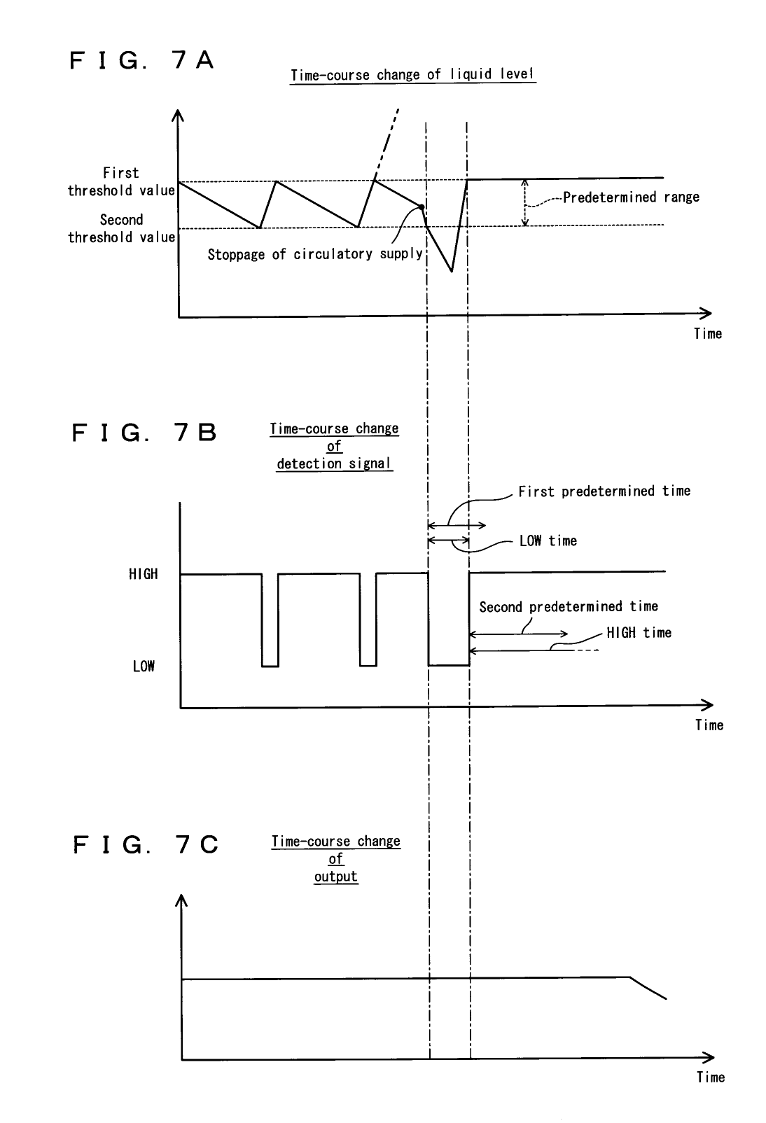

Next, reference will be made to FIG. 7A and FIG. 7B, to describe an example of time-course changes of the liquid level and of the detection signal in the case where the HIGH time exceeds the second predetermined time. FIG. 7A and FIG. 7B show time-course changes in a case where it becomes impossible to circularly supply aqueous methanol solution to the cell stack 102 due to a failure in the aqueous solution pump 132 during power generation.

As shown in FIG. 7A, when circulatory supply of aqueous methanol solution is stopped due to a failure in the aqueous solution pump 132 during power generation, bubbles in the aqueous solution tank 116 begin to disappear, and the liquid level drops quickly until the second threshold value is reached. When the liquid level reaches the second threshold value, supply of water is started. However, since the rate of decrease in the liquid level due to disappearing bubbles is large, it is impossible to increase the liquid level although the rate of decrease in the liquid level becomes slightly smaller than before the supply of water was started. Thus, the liquid level continues to decrease until the bubbles have disappeared completely. Then, when the bubbles have disappeared completely, the liquid level increases with the supply of water, and when the liquid level reaches the first threshold value, the supply of water is stopped. Thereafter, the liquid level does not decrease since circulatory supply is stopped, and as shown in FIG. 7B, the HIGH time exceeds the second predetermined time. As described, if circulatory supply is stopped due to a failure in the aqueous solution pump 132, the output from the cell stack 102 begins to decrease due to continued methanol consumption at the anode 104b (See FIG. 7C), resulting in stoppage of power generation and deterioration of the fuel cell 104.

It should be noted here that even if circulatory supply has been stopped and the liquid level has reached the first threshold value as described, there can be cases where the liquid level decreases to or below the second threshold value, causing an input of the detection signal LOW to the CPU 152 before the second predetermined time has exceeded, due to vibration, tilting, etc., of the motorbike 10. In such a case where the detection signal LOW is inputted due to a mis-detection, water is supplied to the aqueous solution tank 116, so eventually, the liquid level no longer drops to a level not higher than the second threshold value due to vibration, tilting, etc. In other words, if circulatory supply is stopped due to a failure (stoppage) of the aqueous solution pump 132, an eventual situation is simply that the CPU 152 receives only the detection signal HIGH, which will cause the HIGH time to exceed the second predetermined time.

Beside these cases, there can be a case where, for example, it becomes impossible to stop water supply due to a failure in the water pump 140. In this case, as shown in two-dot chain lines in FIG. 7A, the liquid level in the aqueous solution tank 116 continues to increase, and the HIGH time exceeds the second predetermined time. Since circulatory supply is continued and the concentration adjustment is performed at a predetermined interval, power generation is continued. However, because the concentration of aqueous methanol solution decreases, the output from the cell stack 102 drops. Further, there is a risk that aqueous methanol solution will overflow from the aqueous solution tank 116.

Still another example is clogging of the pipes P3 through P6, etc., which reduces the rate of liquid level decrease in the aqueous solution tank 116. Under this situation, too, the HIGH time will exceeds the second predetermined time. In this case, the amount of supply of aqueous methanol solution to the cell stack 102 decreases, which poses a risk of decreased output from the cell stack 102 and deterioration of the fuel cell 104.

As described, there can be various cases where the HIGH time exceeds the second predetermined time. However, in any of the cases, there is an abnormality in the radiator 108a, the aqueous solution tank 116, the aqueous solution pump 132, the water pump 140 or the pipes P3 through P6.

It should be noted here that although vibration from the motorbike 10 creates fluctuating movement of aqueous methanol solution in the aqueous solution tank 116, normally, the cycle of fluctuation is much shorter than a normal LOW time (about two seconds, for example: See FIG. 4B). Therefore, if the detection signal changes from LOW to HIGH or from HIGH to LOW within a half period (about one second, for example, in the present preferred embodiment) of the normal LOW time for example, such a change may simply be ignored. This arrangement reduces chances for misdetection.

According to the fuel cell system 100 as described, it is easy to detect an abnormality which exists in the radiator 108a, the aqueous solution tank 116, the water tank 118, the aqueous solution pump 132, the water pump 140 or the pipes P3 through P6, P13, P14, based on a result of comparison between the LOW time and the first predetermined time as well as on a result of comparison between the HIGH time and the second predetermined time. In other words, it is possible to detect an abnormality easily, through comparison of a virtually ongoing time-course change of the liquid level up to the current time point against a normal pattern of time-course change of the liquid level. If an abnormality exists, operation of the system components is stopped forcibly to stop power generation in the cell stack 102. With this arrangement, it becomes possible to reduce deterioration of the fuel cell 104, as well as to prevent the cell stack 102 from having a shortened life. Also, it becomes possible to prevent aqueous methanol solution from overflowing out of the aqueous solution tank 116 if the liquid level in the aqueous solution tank 116 continues to rise. Further, through notification of the existence of abnormality by using the display portion 28b, it becomes possible for the user of the fuel cell system 100 to take corrective actions such as repairing. As described, power generation in the cell stack 102 is stopped and an abnormality notification is provided when there is an abnormality, whereby it becomes possible to protect the fuel cell system 100.

The system may include a simple level sensor 122 which is only capable of detecting that the liquid level in the aqueous solution tank 116 has reached one of the first threshold value and the second threshold value, and thus, it is possible to reduce cost of the fuel cell system 100.

The CPU 152 is preferably only capable of determining whether the LOW time is longer than the first predetermined time, and whether the HIGH time is longer than the second predetermined time, and therefore it is easy to detect the abnormality.

As compared to stationary equipment, the motorbike 10 is more prone to abnormalities developing in the constituent components of fuel cell system 100 because of vibration, etc., which associates the use. According to the fuel cell system 100, it is easy to detect existence of an abnormality, and is possible to protect the system reliably. Therefore, the fuel cell system 100 can be used suitable to transportation equipment such as the motorbike 10.

It should be noted here that the first predetermined time may be set to any value as long as it is longer than the longest, normally assumable LOW time and is shorter than the time from stoppage of circulatory supply to decrease of the output. Likewise, the second predetermined time may be set to any value as long as it is longer than a normal HIGH time and is shorter than the time from stoppage of circulatory supply to decrease of the output.

The first and the second predetermined times may be variable. For example, the first predetermined time may be varied to compensate for aging deterioration of the cell stack 102. Specifically, the first predetermined time may be varied in accordance with a total power generation time of the cell stack 102. The amount of aqueous methanol solution consumed by the cell stack 102 decreases as the cell stack 102 becomes older. Thus, it is possible to set an appropriate first predetermined time based on a total power generation time of the cell stack 102. Likewise, the second predetermined time may be varied as the water pump 140 becomes older and its performance (output) deteriorates. Specifically, the second predetermined time may be varied in accordance with a total operation time of the water pump 140. A required time, which is an amount of time necessary for increasing the liquid level in the aqueous solution tank 116 from the second threshold value to the first threshold value, becomes longer as the water pump 140 becomes older and its performance decreases. Thus, it is possible to set an appropriate second predetermined time based on a total operation time of the water pump 140. Besides these, other arrangements may include varying the first and the second predetermined times based on operating (running) conditions of the motorbike 10, layout, etc.

Further, in the above-described preferred embodiments, description was made for a case where the liquid level in the aqueous solution tank 116 is increased from the second threshold value to the first threshold value by supplying water. However, the liquid level in the aqueous solution tank 116 may be increased by supplying (replenishing) water and methanol fuel. In this case, the liquid level adjusting unit includes not only the water tank 118, the water pump 140, the CPU 152 and the pipes P13, P14 but also the fuel tank 114 which defines the fuel container, as well as the fuel pump 128 which defines the fuel supply unit and the pipes P1, P2. In this case, the amount of methanol fuel to be supplied should be set to a value which will bring, after supplying the water and the methanol fuel, the aqueous methanol solution in the aqueous solution tank 116 to an appropriate concentration (about 3 wt. %, for example) for power generation. Obviously, if an abnormality exists in whichever of the fuel container and the fuel supply unit of such a liquid level adjusting unit, it becomes impossible to perform appropriate concentration adjustment.

It should be noted here that in the preferred embodiments described above, detection is made for an event that the liquid level in the aqueous solution tank 116 has reached one of the first threshold value and the second threshold value. However, the present invention is not limited to this. Specifically, detection of an abnormality may be based on an actual time-course change of the liquid level. For example, detection of an abnormality may be based on the amount of change in the liquid level per unit time.

Also in the preferred embodiments described above, description was made for a case where an abnormality event is notified by using the display portion 28b. However, the notification unit is not limited to this. For example, the notification unit may be configured to use a speaker for example, so that the abnormality will be notified in the form of voice message, warning sound, etc.

Further, in the preferred embodiments described above, description was made for a case where methanol is used as the fuel, and aqueous methanol solution is used as the aqueous fuel solution. However, the present invention is not limited to this, and the fuel may be provided by other alcoholic fuel such as ethanol, and the aqueous fuel solution may be provided by aqueous solution of the alcohol, such as aqueous ethanol solution.

It should be noted here that the fuel cell system according to preferred embodiments of the present invention is applicable suitably not only to motorbikes but also to any transportation equipment such as automobiles and marine vessels.

Also, the present invention is applicable to stationary type fuel cell systems as long as a liquid fuel is used. Further, the present invention is applicable to portable type fuel cell systems for electronic devices such as personal computers and mobile electronic devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fuel cell system comprising:
a fuel cell;
an aqueous solution container arranged to hold aqueous fuel solution to be supplied to the fuel cell;
a circulation unit arranged to circularly supply the aqueous fuel solution held in the aqueous solution container to the fuel cell;
a liquid level detector arranged to detect a liquid level in the aqueous solution container;
a liquid level adjusting unit arranged to make an adjustment to maintain the liquid level in the aqueous solution container within a predetermined range based on a result of detection by the liquid level detector; and
an abnormality detector arranged to detect an abnormality existing in the aqueous solution container, the circulation unit or the liquid level adjusting unit, based on a time-course change of the result of detection made by the liquid level detector.

2. The fuel cell system according to claim 1, wherein the liquid level detector is arranged to detect that the liquid level in the aqueous solution container has reached either one of an upper limit and a lower limit of the predetermined range, and the abnormality detector is arranged to detect the abnormality based on a result of comparison between a predetermined amount of time and a required time which is a time for the detection result provided by the liquid level detector to change from one to the other of the upper limit and the lower limit of the predetermined range.

3. The fuel cell system according to claim 2, wherein the abnormality detector is arranged to determine that the abnormality exists, if the required time has exceeded the predetermined time.

4. A fuel cell system comprising:
a fuel cell;
an aqueous solution container arranged to hold aqueous fuel solution to be supplied to the fuel cell;
a circulation unit arranged to circularly supply the aqueous fuel solution held in the aqueous solution container to the fuel cell;
a liquid level detector arranged to detect a liquid level in the aqueous solution container;
a liquid level adjusting unit arranged to make an adjustment to maintain the liquid level in the aqueous solution container within a predetermined range based on the result of detection by the liquid level detector; and
a stopping unit arranged to stop power generation in the fuel cell based on a time-course change of the result of detection made by the liquid level detector.

5. A fuel cell system comprising:
a fuel cell;
an aqueous solution container arranged to hold aqueous fuel solution to be supplied to the fuel cell;
a circulation unit arranged to circularly supply the aqueous fuel solution held in the aqueous solution container to the fuel cell;
a liquid level detector arranged to detect a liquid level in the aqueous solution container;
a liquid level adjusting unit arranged to make an adjustment to maintain the liquid level in the aqueous solution container within a predetermined range based on a result of detection by the liquid level detector; and
a notification unit arranged to provide a notification that an abnormality exists in the aqueous solution container, the circulation unit or the liquid level adjusting unit, based on a time-course change of the result of detection made by the liquid level detector.

6. Transportation equipment comprising the fuel cell system according to claim 1.

7. Transportation equipment comprising the fuel cell system according to claim 2.

8. Transportation equipment comprising the fuel cell system according to claim 3.

9. Transportation equipment comprising the fuel cell system according to claim 4.

10. Transportation equipment comprising the fuel cell system according to claim 5.
